(19) United States
(12) Patent Application Publication
(10) Pub. No.: US 2011/0096063 A1
(43) Pub. Date: Apr. 28, 2011

(54) DISPLAY APPARATUS AND POWER SUPPLY METHOD THEREOF

(75) Inventor: Young-soo KIM, Hwaseong-si (KR)

(73) Assignee: SAMSUNG ELECTRONICS CO., LTD., Suwon-si (KR)

(21) Appl. No.: 12/903,813

(22) Filed: Oct. 13, 2010

(30) Foreign Application Priority Data
Oct. 25, 2009 (KR) 10-2009-0101497

(51) Int. Cl. G06F 3/038; G05F 1/70; H05B 37/02

(52) U.S. Cl. 345/212; 323/207; 315/307

(57) ABSTRACT

There is provided a display apparatus including: a signal receiving unit which receives an image signal; a signal processing unit which processes the image signal; a display unit which displays an image based on the image signal; and a power supply unit which supplies an operational voltage to the display unit. The power supply unit includes: a voltage converting unit which converts a DC voltage to output the operational voltage; a feedback part which outputs a feedback voltage according to the DC voltage; a power factor correcting unit which performs power factor correction based on the feedback voltage output; and a power saving unit which controls the output of the feedback unit according to an operational state of the power factor correcting unit.

### CROSS-REFERENCE TO RELATED APPLICATION

This application claims priority from Korean Patent Application No. 10-2009-0101497, filed on Oct. 25, 2009 in the Korean Intellectual Property Office, the disclosure of which is incorporated herein by reference.

### BACKGROUND

1. Field

Apparatuses and methods consistent with the exemplary embodiments relate to a display apparatus which is capable of preventing power consumption in a standby mode, and a power supply method thereof.

2. Description of Related Art

In general, a display apparatus such as a television is provided with a power supply unit such as a Switching Mode Power Supply (SMPS) for supply of operational power. The power supply unit is supplied with commercial alternating current (AC) power, converts the AC power to an operational power of a necessary level, and supplies the operational power for target components. Further, the power supply unit may perform a power factor correction to obtain maximum effective power. The power factor correction is performed using a Power-Factor-Correction (PFC) circuit, which performs voltage boosting to perform the power factor correction. The PFC circuit uses a resistor for detecting the boost level so that the boosted voltage does not exceed a predetermined level.

On the other hand, the display apparatus may have a standby mode for power saving. In such a standby mode, the PFC circuit may not operate. However, in a related art PFC circuit, since the resistor for detecting the boost level is fixedly connected to the PFC circuit, power consumption occurs in the standby mode in which the PFC circuit does not operate. Such power consumption due to the resistor may occur in a variety of electronic devices having the above-described power supply mechanism as well as the display apparatus.

### SUMMARY

Exemplary embodiments provide a display apparatus which prevents power consumption due to a resistor provided in a PFC circuit when the PFC circuit does not operate, for example, in a standby mode, and a power supply method thereof.

According to an aspect of an exemplary embodiment, there is provided a display apparatus including: a signal receiving unit which receives an image signal; a signal processing unit which processes the image signal received in the signal receiving unit; a display unit which displays an image based on the image signal processed in the signal processing unit; and a power supply unit which supplies an operational voltage to the display unit, the power supply unit including: a voltage converting unit which converts a level of a direct current (DC) voltage obtained from an AC voltage to output the operational voltage, a feedback unit which outputs a feedback voltage according to the DC voltage, a power factor correcting unit which performs a power factor correction of the power supply unit based on the feedback voltage output from the feedback unit, and a power saving unit which controls the output of the feedback unit according to an operational state of the power factor correcting unit.

The power saving unit may prevent an electric current from flowing in the feedback unit in response to the power factor correcting unit being turned off, to cut off the output of the feedback voltage.

The feedback unit may include at least one resistor and the power saving unit may include a switching element connected with the resistor of the feedback unit, wherein the power saving unit may cut off the output of the feedback unit by operation of the switching element when the power factor correcting unit is turned off.

The display apparatus may operate in a standby mode when the power factor correcting unit is turned off.

The power supply unit may further include a driving voltage supply unit which supplies a driving voltage to the power factor correcting unit; and a switch which controls the supply of the driving voltage to the power factor correcting unit, wherein the switching element of the power saving unit may cut off the output of the feedback voltage when the switch is turned off.

According to an aspect of another exemplary embodiment, there is provided a power supply method which converts a level of a DC voltage obtained from an AC voltage to output an operational voltage to an apparatus, the method including: outputting a feedback voltage according to the DC voltage; performing, by a power factor correcting unit, a power factor correction based on the output feedback voltage; and controlling the outputting of the feedback voltage according to an operational state of the power factor correcting unit.

The controlling the outputting may include preventing an electric current from flowing in a feedback element which outputs the feedback voltage.

The display apparatus may operate in a standby mode when the power factor correcting unit is in an off state.

The method may further include supplying a driving voltage to the power factor correcting unit to perform the power factor correction, wherein the controlling the outputting may further include cutting off the outputting of the feedback voltage when the supplying of the driving voltage is cut off.

According an aspect of another exemplary embodiment, there is provided a power supply unit which supplies an operational voltage to a device having plural operational states, the power supply unit including: a feedback unit which outputs a feedback voltage according to an input DC voltage to be output as the operational voltage; a power factor correcting unit which performs a power factor correction of the power supply unit based on the feedback voltage output from the feedback unit; and a power saving unit which controls the output of the feedback unit according to an operational state of the power factor correcting unit corresponding to an operational state of the device.

According to an aspect of the exemplary embodiments, when a PFC circuit does not operate, for example, in a standby mode, an electric current is prevented from flowing in a resistor which controls voltage boosting, thereby preventing unnecessary power consumption in the resistor.

### BRIEF DESCRIPTION OF DRAWINGS

The above and/or other aspects will become apparent and more readily appreciated from the following description of the exemplary embodiments, taken in conjunction with the accompanying drawings, in which:

FIG. 1 illustrates a configuration of a display apparatus according to an exemplary embodiment;

FIG. 2 is a circuit diagram illustrating a configuration of a power supply unit in a display apparatus according to an exemplary embodiment;

FIG. 3 is a diagram for illustrating an operational process of a power supply unit in a display apparatus according to an exemplary embodiment;

FIG. 4 is a circuit diagram illustrating a configuration of a power supply unit in a display apparatus according to another exemplary embodiment; and

FIG. 5 is a flowchart for illustrating an operational power supply process of a display apparatus according to an exemplary embodiment.

### DETAILED DESCRIPTION OF EXEMPLARY EMBODIMENTS

Reference will now be made in detail to exemplary embodiments, examples of which are illustrated in the accompanying drawings, wherein like reference numerals refer to like elements throughout. The exemplary embodiments are described below so as to explain the present inventive concept by referring to the figures. Redundant description to different exemplary embodiments may be omitted for simplicity of description.

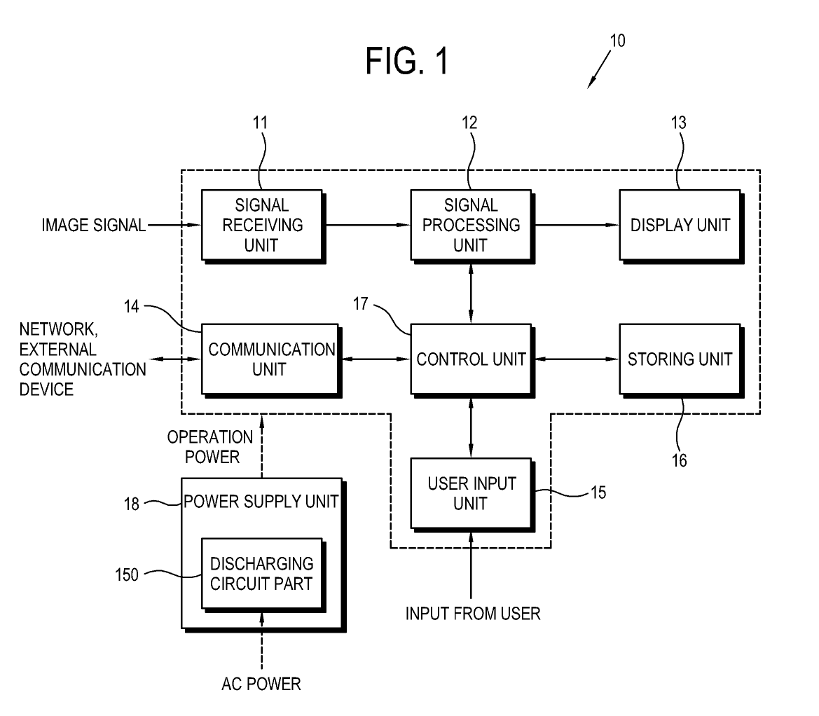

FIG. 1 illustrates a configuration of a display apparatus 10 according to an exemplary embodiment. The display apparatus 10 receives and processes an image signal to be displayed, and may be provided as a television. As shown in FIG. 1, the display apparatus 10 includes a signal receiving unit 11, a signal processing unit 12, a display unit 13, a communication unit 14, a user input unit 15, a storing unit 16, and a controller 17.

The signal receiving unit 11 receives an image signal from an external source. The image signal received in the signal receiving unit 11 may include a broadcast signal such as a digital television (DTV) signal or a cable broadcast signal. In this case, the signal receiving unit 11 may receive a broadcast signal through a channel selected by a user under the control of the control unit 17. The image signal may include a signal output from an image display apparatus such as a Digital Versatile Disc (DVD) player or a Blu-ray disk (BD) player. Further, the signal receiving unit 11 may receive an audio signal for output of audio, a data signal for output of data information, or the like. The image signal, the audio signal and the data signal may be received through a single signal.

The signal processing unit 12 processes the image signal received in the signal receiving unit 11 to be displayed through the display unit 13. The image processing performed by the signal processing unit 12 may include decoding, image enhancing, scaling and the like. Further, the signal processing unit 12 may process the audio signal and the data signal received in the signal receiving unit 11.

The display unit 13 displays an image based on the image signal processed in the signal processing unit 12. The display unit 13 may employ a liquid crystal display (LCD), which may include an LCD panel, a panel driver, a back light unit, and the like. However, it is understood that embodiments are not limited thereto. For example, the display unit 13 may alternatively employ a plasma display, a cathode ray tube (CRT) display, an organic light emitting diode (OLED) display, or the like. Further, the display unit 13 may display data information included the data signal processed in the signal processing unit 12.

The display apparatus 10 may further include an audio output part (not shown) such as a speaker which outputs audio based on the audio signal processed in the signal processing unit 12.

The communication unit 14 performs communication with an external communication device through a network, for example, through the Internet. Alternatively, the communication unit 14 may perform communication with the external communication device in a near field communication method, for example, through Bluetooth. The communication unit 14 may transmit information to the external communication device or receive information from the external communication device, under the control of the control unit 17. The information received from the external communication device through the communication unit 14 may include images, audio, and/or data, which may undergo suitable processing and then may be output through the display unit 13 or the like.

The user input unit 15 is used to receive a user input, and may be provided as a remote controller, a manipulation panel or the like. The user input unit 15 may include an input key for selection of power on/off for the display apparatus 10. The user input received through the user input unit 15 is transmitted to the control unit 17.

The storing unit 16 stores data or information in the display apparatus 10, and may be provided as, for example, a non-volatile memory such as a flash memory, a hard disk or the like.

The control unit 17 controls the components of the display apparatus 10 as a whole, and may include firmware which is a control program, and a central processing unit (CPU) and a random-access memory (RAM) for execution of the control program.

The display apparatus 10 further includes a power supply unit 18 which supplies operational power to the components such as the display unit 13. The power supply unit 18 is supplied with commercial AC power, and converts the AC power into power of an operational level to be supplied to each component. In FIG. 1, illustration of a specific path for the power supply to each component such as the display unit 13 from the power supply unit 18 is omitted for simplicity of illustration.

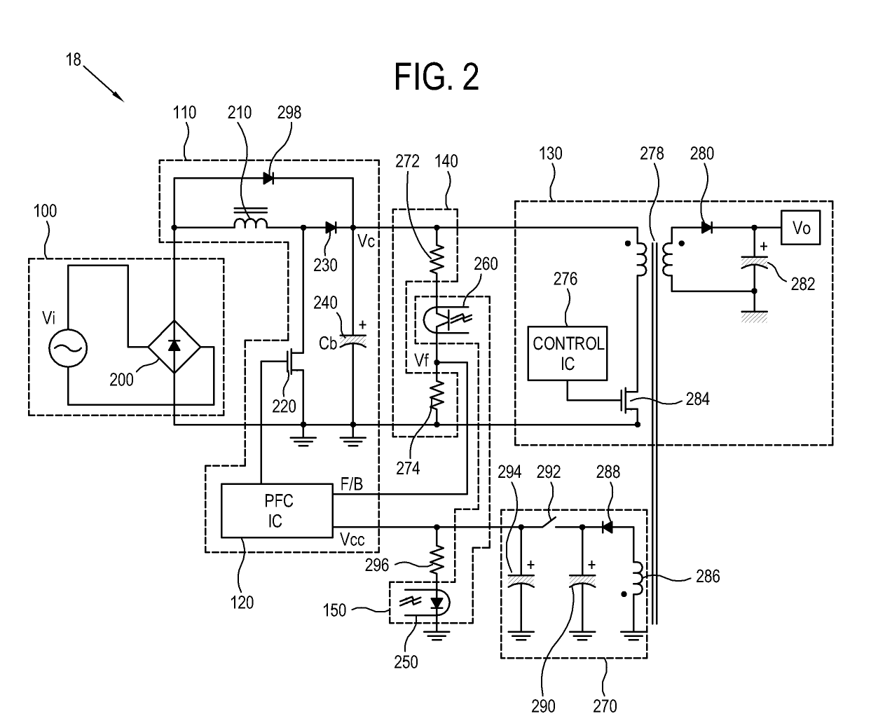

The power supply unit 18 according to the present exemplary embodiment includes a discharging circuit unit 150 which prevents unnecessary power consumption in a standby mode. Hereinafter, the power supply unit 18 according to the present exemplary embodiment will be described in detail with reference to FIGS. 2 to 4.

FIG. 2 is a circuit diagram illustrating a configuration of the power supply unit 18 in the display apparatus 10 according to an exemplary embodiment. As shown in FIG. 2, the power supply unit 18 includes a rectifying unit 100, a power factor correcting unit 110, a feedback unit 140, and a voltage converting unit 130.

The rectifying unit 100 rectifies an input AC voltage to convert an alternating current voltage into a direct current voltage. The rectifier 100 may be provided as, for example, a bridge diode 200.

The power factor correcting unit 110 includes a smoothing capacitor 240 for smoothing the direct current voltage output from the rectifying unit 100. Further, the power factor correcting unit 110 includes an inductor 210, a first diode 230, a first Field Effect Transistor (FET) 220, a PFC Integrated Circuit (IC) 120, and a second diode 298. The PFC IC 120 switches the first FET 220 in a predetermined duty ratio to boost voltage charged in the smoothing capacitor 240, and thereby enhance a power factor of the power supply unit 18.

The process of charging the voltage in the smoothing capacitor 240 is performed as follows. If the first FET 220 is turned on, an electric current does not flow through the second diode 230, but flows in the inductor 210, and thus, energy is accumulated in the inductor 210. In this respect, since the energy accumulated in the inductor 210 is not supplied to the smoothing capacitor 240, the voltage charged in the smoothing capacitor 240 is not boosted.

If the first FET 220 is turned off, the electric current flows through the second diode 230, and thus, the energy accumulated in the inductor 210 is supplied to the smoothing capacitor 240, to thereby supply the energy of the inductor 210 to the smoothing capacitor 210. The energy accumulated in the inductor 210 increases corresponding to the turn-on time of the first FET 220, and thus, the energy charged in the smoothing capacitor 240 increases. The PFC IC 120 may control the turn-on time of the first FET 220 to control the energy accumulated in the inductor 210 and thus the energy charged in the smoothing capacitor 240.

The feedback unit 140 includes a first resistor 272 and a second resistor 274 which are connected in parallel with the smoothing capacitor 240. The feedback unit 140 outputs a feedback voltage Vf according to a voltage Vc charged in the smoothing capacitor 240 to the power factor correcting unit 110 for operation of the power factor correcting unit 110. As shown in FIG. 2, the feedback voltage Vf becomes a voltage obtained by distributing the voltage Vc charged in the smoothing capacitor 240 to the first resistor 272 and second resistor 274, that is, a voltage applied to opposite ends of the second resistor 274.

The power factor correcting unit 110 detects the feedback voltage Vf output from the feedback unit 140 to estimate the level of the voltage Vc charged in the smoothing capacitor 240. The voltage Vc charged in the smoothing capacitor 240 may be estimated by resistance values of the first resistor 272 and the second resistor 274. The voltage Vc charged in the smoothing capacitor 240 may be controlled to maintain a voltage of about 390 V to 400 V, though an exemplary embodiment is not limited thereto. If the voltage Vc charged in the smoothing capacitor 240 exceeds a predetermined maximum voltage, for example, 400 V, the PFC IC 120 decreases the turn-on time of the first FET 220 to decrease the energy accumulated in the inductor 210, thereby preventing excessive increase in the voltage Vc of the smoothing capacitor 240. Contrarily, if the voltage Vc charged in the smoothing capacitor 240 does not reach the predetermined maximum voltage, the PFC IC 120 increases the turn-on time of the first FET 220 to allow more energy to be accumulated in the inductor 210, thereby increasing the voltage Vc charged in the smoothing capacitor 240.

The voltage converting unit 130 converts the level of the voltage Vc output from the power factor correcting unit 110 to output an operational voltage Vo to each component such as the display unit 13. As shown in FIG. 2, the voltage converting unit 130 includes a transforming unit 278 which is connected to an output end of the power factor correcting unit 110; a second FET 284 which is connected in series with a primary coil side of the transforming unit 278 to control electric current flow; a control IC 276 which switches the second FET 284; a third diode 280 which is provided in a secondary coil side of the transforming unit 278 and rectifies the output operational voltage Vo; and a first capacitor 282 which maintains the level of the operational voltage Vo.

The control IC 276 switches the second FET 284 so that the level of the operational voltage Vo reaches a predetermined target value. The operational voltage Vo is a voltage used for operation of each component such as the display unit 13, the level of which corresponds to each component to which the operational voltage Vo is supplied. For example, the operational voltage Vo supplied to a chip such as a CPU or a microcomputer which may be implemented as the control unit 17 may be about 5 V. The number of operational voltages Vo may be one or more. If the number of operational voltages Vo is more than one, the voltage converting unit 130 may additionally include components which are the same as or similar to the second coil of the transforming unit 278, the third diode 280 and the first capacitor 282, so as to respectively correspond to each operational voltage Vo. In this case, the levels of the plural operational voltages Vo may correspond to the target components, respectively, and may be different from each other.

The display apparatus 10 according to the present exemplary embodiment has a normal mode in which the display apparatus 10 normally operates, for example, to display an image in the display unit 13, and a standby mode in which the display apparatus 10 consumes minimum power. The control IC 276 controls the second FET 284 so that an operational voltage Vo of a necessary or desired level is supplied to the component which operates in the standby mode, for example, to a microcomputer (not shown) which performs a standby mode control.

The power factor correcting unit 110 may not operate in the standby mode, but may operate in the normal mode. In this respect, the power supply unit 18 may further include a driving voltage supply unit 270 which supplies a PFC driving voltage Vcc to the power factor correcting unit 110. The driving voltage supply unit 270 includes a third coil 286, a fourth diode 288, a second capacitor 290, a third capacitor 294 and a power switch 292. To the third coil 286 is induced a predetermined voltage by the second coil of the transforming unit 278. The voltage induced to the third coil 286 is charged in the second capacitor 290. The power switch 292 controls a connection between the second capacitor 290, the fourth diode 288, and the third capacitor 294. If the power switch 292 is closed, the voltage charged in the capacitor 290 is supplied to the third capacitor 294, or the voltage induced to the third coil 286 is charged in the third capacitor 294. The third capacitor 294 is connected to the PFC IC 120 to supply the charged voltage as a PFC driving voltage Vcc.

In the standby mode, the power switch 292 is opened. In this state, the PFC driving voltage Vcc is not supplied to the PFC IC 120, and thus, the power factor correcting unit 110 is in an off state. Contrarily, if a user turns on power through the user input unit 15, a corresponding power on signal is transmitted to the power switch 292 to close the power switch 292. In this state, the PFC driving voltage Vcc is supplied the PFC IC 120, and thus, the power factor correcting unit 110 normally operates.

The discharging circuit unit 150 cuts off, if the operation of the power factor correcting unit 110 is caused to stop, the output of the feedback voltage Vf from the feedback unit 140, to thereby prevent power consumption in the feedback unit 140. The operation of the power factor correcting unit 110 may stop in the case that the display apparatus 10 enters into the standby mode. As shown in FIG. 2, the discharging circuit unit 150 includes a photo-coupler 250 and 260. The photo-coupler 250 and 260 includes a light emitting unit 250 and a light receiving unit 260. If an electric current flows in the light emitting unit 250, the light emitting unit 250 emits light which is received by the light receiving unit 260. If the intensity of the received light is greater than or equal to a predetermined value, the light receiving unit 260 is turned on. According to the present exemplary embodiment, one end of the light emitting unit 250 is connected with an input end of the driving voltage Vcc of the PFC IC 120 through a third resistor 296. The other end of the light emitting unit 250 is connected to a ground. The light receiving unit 260 is connected between the first resistor 272 and the second resistor 274 of the feedback unit 140.

If the PFC driving voltage Vcc is supplied to the PFC IC 120, the electric current flows in the light emitting unit 250 to emit light, and the light receiving unit 260 receives the light emitted from the light emitting unit 250. If the intensity of the light received in the light receiving unit 260 reaches the predetermined value or more, the light receiving unit 260 is turned on. Thus, the first resistor 272 and the second resistor 274 of the feedback unit 140 are connected to each other, and the electric current flows through the first and second resistors 272 and 274. If the electric current flows in the feedback unit 140, the power factor correcting unit 110 may detect the level of the voltage Vc charged in the smoothing capacitor 240 through the feedback unit 140.

If the PFC driving voltage Vcc is not supplied to the PFC IC 120, the electric current does not flow in the light emitting unit 250, and thus, the light emitting unit 250 does not emit light. Therefore, the light receiving unit 260 does not receive light, and is turned off. Accordingly, the electric current does not flow in the first and second resistors 272 and 274 of the feedback unit 140, and thus, power consumption due to the first and second resistors 272 and 274 does not occur. In this way, since the electric current does not flow in the feedback unit 140 in the case that the feedback unit 140 does not need to operate as in the standby mode, power consumption due to the power consuming components of the feedback unit 140 can be prevented.

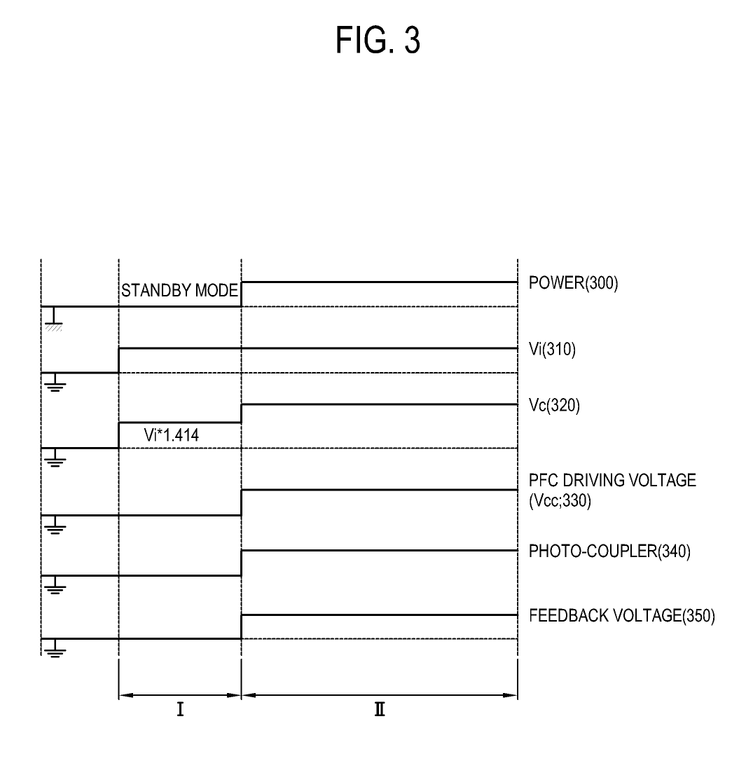

FIG. 3 is a diagram for illustrating an operational process of the power supply unit 18 in the display apparatus 10 according to an exemplary embodiment. In the case that an AC voltage Vi (310) is input and power (300) of the display apparatus 10 is turned off (a section I in FIG. 3), the PFC driving voltage Vcc (330) is not supplied to the PFC IC 120, and thus, is in a low state. In this state, the photo-coupler (340; refer to 250 and 260 in FIG. 2) are in a turn off state. Thus, an electric current does not flow in the second resistor 274 of the feedback unit 140, and the feedback voltage Vf (350) is also in a low state. However, even though the power (300) is turned off, energy is stored in the smoothing capacitor 240 as the AC voltage Vi (310) is input. In this state, a voltage corresponding to Vi*1.414 may be charged in the smoothing capacitor 240.

In the case that the power (300) is turned on (a section II in FIG. 3), the PFC driving voltage (330) of the PFC IC 120 becomes in a high stage, and thus, the light emitting unit 250 and the light receiving unit 260 are turned on. The feedback voltage Vf (350) becomes in a high stage. Therefore, the PFC IC 120 is operated, and thus, the voltage Vc (320) of the smoothing capacitor 240 may be maintained to be about 390V to 400V.

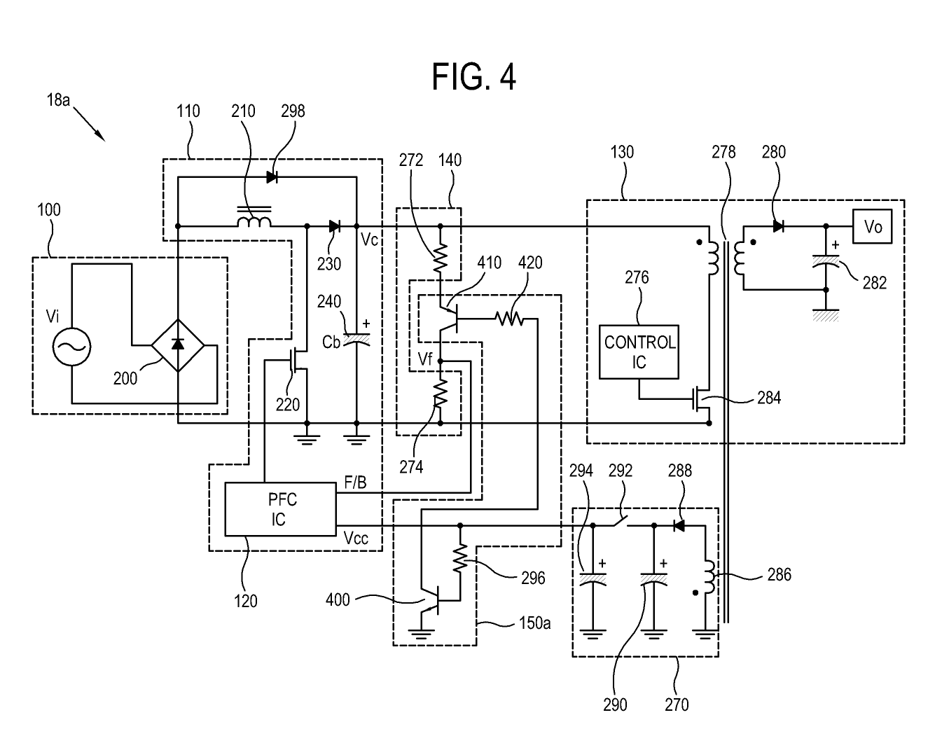

FIG. 4 is a circuit diagram illustrating a configuration of a power supply unit 18a in a display apparatus 10 according to another exemplary embodiment. In this respect, repetitive description of elements of the power supply unit 18a that are similar to the elements of the power supply unit 18 in FIG. 2 will be omitted for simplicity of description.

A discharging circuit unit 150a of the power supply unit 18a according to the present exemplary embodiment includes bipolar transistors 400 and 410, and a resistor 420. The bipolar transistors 400 and 410 include a first transistor 400 and a second transistor 410. If a PFC driving voltage Vcc is supplied to a PFC IC 120, the first and second transistors 400 and 410 are turned on, and thus, an electric current flows in a first resistor 272 and a second resistor 274 of a feedback unit 140. Thus, the PFC IC 120 can detect a voltage Vc charged in a smoothing capacitor 240 through the feedback unit 140 of the PFC IC 120.

If the PFC driving voltage Vcc is not supplied to the PFC IC 120, a base end of the first transistor 400 is not supplied with the voltage, and thus, an electric current does not flow in the first transistor 400. Thus, a connection between the first and second resistors 272 and 274 of the feedback unit 140 is cut off, and the electric current does not flow in the feedback unit 140. In this respect, the first transistor 400 or the second transistor 410 of the discharging circuit unit 150a may be replaced with a Metal Oxide Semiconductor FET (MOSFET).

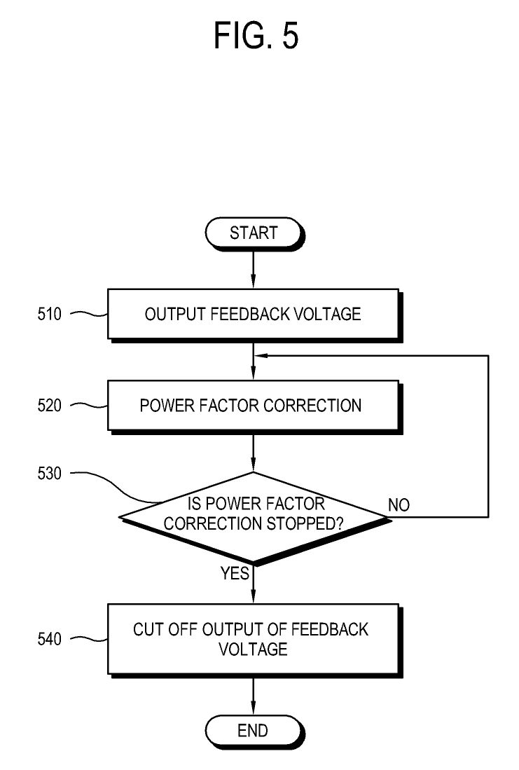

FIG. 5 is a flowchart for illustrating an operational power supply process of the display apparatus 10 according to an exemplary embodiment. According to the power supplying process, if an AC voltage Vi is input, the AC voltage Vi is rectified by the rectifying unit 100 to output a DC voltage. The DC voltage output from the rectifying unit 100 is level-converted by the voltage converting unit 130 and is output as an operational voltage Vo.

As shown in FIG. 5, if the PFC driving voltage Vcc is supplied to the PFC IC 120, the feedback voltage Vf according to the DC voltage Vc charged in the smoothing capacitor 240 is output from the feedback unit 140 in operation 510. The power factor correcting unit 110 boosts the DC voltage up to a predetermined level based on the feedback voltage Vf to perform the power factor correction in operation 520.

If the power factor correction is caused to stop, for example, in the case that the PFC driving voltage Vcc is not supplied to the PFC IC 120 (YES in operation 530), the discharging circuit unit 150 prevents an electric current from flowing in the feedback unit 140 to cut off the output of the feedback voltage Vf in operation 540. If the power factor correction is not stopped (NO in operation 530), operations 510 and 520 are repeated.

Although a few exemplary embodiments have been shown and described, it will be appreciated by those skilled in the art that changes may be made in these exemplary embodiments without departing from the principles and spirit of the inventive concept, the scope of which is defined in the appended claims and their equivalents.

What is claimed is:

1. A display apparatus comprising:
a signal receiving unit which receives an image signal;
a signal processing unit which processes the received image signal;
a display unit which displays an image based on the processed image signal; and
a power supply unit which supplies an operational voltage to the display unit, the power supply unit comprising:
a voltage converting unit which converts a level of a direct current (DC) voltage obtained from an alternating current (AC) voltage to output the operational voltage,
a feedback unit which outputs a feedback voltage according to the DC voltage,
a power factor correcting unit which performs a power factor correction of the power supply unit based on the feedback voltage output from the feedback unit, and
a power saving unit which controls the feedback voltage output by the feedback unit according to an operational state of the power factor correcting unit.

2. The display apparatus according to claim 1, wherein the power saving unit prevents an electric current from flowing in the feedback unit when the power factor correcting unit is turned off, to cut off the output of the feedback voltage.

3. The display apparatus according to claim 2, wherein:
the feedback unit comprises at least one resistor;
the power saving unit comprises a switching element connected with the at least one resistor of the feedback unit; and
the power saving unit cuts off the output of the feedback unit by operation of the switching element when the power factor correcting unit is turned off.

4. The display apparatus according to claim 1, wherein the display apparatus operates in a standby mode when the power factor correcting unit is turned off.

5. The display apparatus according to claim 3, wherein:
the power supply unit further comprises:
a driving voltage supply unit which supplies a driving voltage to the power factor correcting unit, and
a switch which controls the supply of the driving voltage by the driving voltage supply unit to the power factor correcting unit; and
wherein the switching element of the power saving unit cuts off the output of the feedback voltage when the switch is turned off so that the driving voltage is not supplied to the power factor correcting unit.

6. The display apparatus according to claim 5, wherein the switching element comprises:
a light emitting unit which emits a light when the switch is turned on so that the driving voltage is supplied by the driving voltage supply unit to the power factor correcting unit; and
a light receiving unit which is connected to the at least one resistor of the feedback unit, receives the light emitted from the light emitting unit, controls the at least one resister so that the electric current does flow in the feedback unit and the output of the feedback voltage is not cut off if an amount of the received light reaches a predetermined value, and controls the at least one resistor so that the electric current does not flow in the feedback unit and the output of the feedback voltage is cut off if the amount of the received light is not greater than or equal to the predetermined value or if no light is received by the light receiving unit.

7. The display apparatus according to claim 5, wherein the switching element comprises:
first and second bipolar transistors which control the at least one resistor so that electric current does not flow in the feedback unit and the output of the feedback voltage is cut off when the switch is turned off, and which control the at least one resistor such that the electric current does flow in the feedback unit and the feedback unit outputs the feedback voltage when the switch is turned on.

8. A power supply method which converts a level of a direct current (DC) voltage obtained from an alternating current (AC) voltage to output an operational voltage to an apparatus, the method comprising:
outputting a feedback voltage according to the DC voltage;
performing, by a power factor correcting unit, a power factor correction based on the feedback voltage; and
controlling the outputting of the feedback voltage according to an operational state the power factor correcting unit.

9. The method according to claim 8, wherein the controlling the outputting of the feedback voltage comprises preventing an electric current from flowing in a feedback element which outputs the feedback voltage when the power factor correcting unit is turned off, to prevent the outputting of the feedback voltage.

10. The method according to claim 8, wherein the operational state of the power factor correcting unit is an off state when the apparatus operates in a standby mode.

11. The method according to claim 8, further comprising:
supplying a driving voltage to the power factor correcting unit to perform the power factor correction,
wherein the controlling the outputting of the feedback voltage comprises cutting off the outputting of the feedback voltage when the supplying of the driving voltage is cut off.

12. The method according to claim 11, wherein the cutting off the outputting of the feedback voltage comprises:
emitting, by a light emitting unit, a light in response to the supplying of the driving voltage;
receiving, by a light receiving unit which is connected to at least one resistor of a feedback element which outputs the feedback voltage, the emitted light; and
controlling, by the light receiving unit, the at least one resistor so that electric current does flow in the feedback unit and the outputting of the feedback voltage is not cut off if an amount of the received light reaches a predetermined value, and controlling the at least one resistor so that the electric current does not flow in the feedback unit and the outputting of the feedback voltage is cut off if the amount of the received light is not greater than or equal to the predetermined value or if no light is received by the light receiving unit.

13. The method according to claim 11, wherein the cutting off the outputting of the feedback voltage comprises:
in response to the supplying of the driving voltage being cut off, controlling, by first and second bipolar transistors, at least one resistor connected to a feedback element which outputs the feedback voltage, so that electric current does not flow in the feedback unit and the outputting of the feedback voltage is cut off.

14. A power supply unit which supplies an operational voltage to a device having plural operational states, the power supply unit comprising:
a feedback unit which outputs a feedback voltage according to an input DC voltage to be output as the operational voltage;
a power factor correcting unit which performs a power factor correction of the power supply unit based on the feedback voltage output from the feedback unit; and
a power saving unit which controls the output of the feedback unit according to an operational state of the power factor correcting unit corresponding to an operational state of the device.

15. The power supply unit according to claim 14, wherein the power saving unit prevents an electric current from flowing in the feedback unit in response to the power factor correcting unit being turned off, to cut off the output of the feedback voltage.

16. The power supply unit according to claim 15, wherein:
the feedback unit comprises at least one resistor;
the power saving unit comprises a switching element connected with the at least one resistor of the feedback unit; and
the power saving unit cuts off the output of the feedback unit by operation of the switching element when the power factor correcting unit is turned off.

17. The power supply unit according to claim 14, wherein the operational state of the device is a standby mode when the power factor correcting unit is turned off.

18. The power supply unit according to claim 16, further comprising:
a driving voltage supply unit which supplies a driving voltage to the power factor correcting unit; and
a switch which controls the supply of the driving voltage by the driving voltage supply unit to the power factor correcting unit,
wherein the switching element of the power saving unit cuts off the output of the feedback voltage when the switch is turned off so that the driving voltage is not supplied to the power factor correcting unit.

19. The power supply unit according to claim 18, wherein the switching element comprises:
a light emitting unit which emits a light if the switch is turned on such that the driving voltage is supplied by the driving voltage supply unit to the power factor correcting unit; and
a light receiving unit which is connected to the at least one resistor of the feedback unit, receives the light from the light emitting unit, controls the at least one resister so that the electric current does flow in the feedback unit and the output of the feedback voltage is not cut off if an amount of the received light reaches a predetermined value, and controls the at least one resistor so that the electric current does not flow in the feedback unit and the output of the feedback voltage is cut off if the amount of the received light is not greater than or equal to the predetermined value or if no light is received by the light receiving unit.

20. The power supply unit according to claim 18, wherein the switching element comprises:
first and second bipolar transistors which control the at least one resistor so that electric current does not flow in the feedback unit and the output of the feedback voltage is cut off if the switch is turned off, and control the at least one resistor so that the electric current does flow in the feedback unit and the feedback unit outputs the feedback voltage if the switch is turned on.
